(19) United States
(12) Patent Application Publication
(10) Pub. No.: US 2013/0271080 A1
(43) Pub. Date: Oct. 17, 2013

(54) CHARGING SYSTEM AND CHARGING METHOD

(71) Applicant: Nobuhide Yoshida, Tokyo (JP)

(72) Inventor: Nobuhide Yoshida, Tokyo (JP)

(73) Assignee: NEC CORPORATION, Tokyo (JP)

(21) Appl. No.: 13/996,378

(22) PCT Filed: Dec. 16, 2011
(86) PCT No.: PCT/JP2011/079965

§ 371 Date: Jun. 20, 2013

(30) Foreign Application Priority Data
Dec. 21, 2010 (JP) 2010-284138

(51) Int. Cl. B60L 11/18; H02J 7/00

(52) U.S. Cl. CPC B60L 11/1809; H02J 7/0052
USPC 320/109; 320/137

(57) ABSTRACT

[Problem] A charging system and a charging method which make a plurality of power supply circuits for generating electric power of a predetermined power value operate with high conversion efficiency to charge a secondary battery efficiently are provided.

[Solution] The charging system includes an output means which supplies electric power, a plurality of electric power generating means which generate electric power of a predetermined power value, a detection means which detects a state of the output means and a control means which controls the plurality of electric power generating means based on the state that the output means has detected.

### TECHNICAL FIELD

The present invention relates to a charging system and a charging method, and more particularly, to a charging system and a charging method to charge a secondary battery.

### BACKGROUND ART

In recent years, consciousness of aiming at realization of a low carbon society by reducing dependence to fossil fuel is increasing, and an environment for that is being improved. Responding to this situation, activities for popularization of equipment equipped with a secondary battery, such as an electric vehicle (EV) or a plug-in hybrid vehicle (PHV), have become active. Also, a market of such equipment is establishing.

Along with the tendency as above, development of a charger indispensable for the spread of electric vehicles and preparation of charging facilities has been receiving attention. As a charging method of a charger, which is expected to be popular, a method to perform charging in large-scale public facilities and the like, such as a gas station and a shopping center, and a method to perform charging simply from a home power supply, are being proposed. However, secondary batteries being currently put to practical use have large capacities, and a time of no smaller than 10 hours is required for a full charge of a battery for a vehicle in the case of charging from the home power supply. For this reason, it is said that a fast charger (80 percent charging is possible within 20 to 30 minutes) having a capacity of a higher voltage and a larger output (no smaller than 50 kilowatts, for example) is required to be popularized. For this reason, active developments aiming at higher efficiency, higher performance and lower price for fast chargers have been promoted, in recent years.

One of the problems on such fast charger is a waiting time for two or more electric vehicles. That is, when two or more electric vehicles visit a charge facility, a waiting time may occur for electric vehicles which arrived there later. The fewer is a remaining capacity of a battery in a vehicle that has arrived earlier, the longer the waiting time is, and thus, the electric vehicle which arrived later may be forced to wait for 30 minutes.

For the above problem, a countermeasure to install a plurality of chargers in the charge facility has been considered. However, because the size of a charging system, for which an output of large electric power as much as 20 to 50 kilowatts is required, is large, there is a problem in a business aspect, that a site area for installing a plurality of chargers is restricted or the like.

In order to solve the above problem, a configuration for charging two or more electric vehicles simultaneously by one charging system has been proposed. For example, an electric vehicle disclosed in patent document 1 is provided with an electricity receiving inlet that receives electricity from a charger and supplies the electricity to a secondary battery installed in the electric vehicle; and an electricity supply outlet that receives electricity from a terminal of the secondary battery and supplies the electricity to another electric vehicle. According to the above configuration, the two or more electric vehicles are charged simultaneously.

### CITATION LIST

### Patent Document

[Patent document 1] Japanese Patent Application Laid-Open No. H10-117444A

### DISCLOSURE OF THE INVENTION

### Problems to be Solved by the Invention

However, an electricity receiving inlet and an electricity supply inlet are needed to be provided in the body of the electric vehicle disclosed in patent document 1, and thus the configuration of the body becomes complicated. Further, a large capacity power supply apparatus is needed, because a large capacitance is required for the charging system that charges secondary batteries of two or more electric vehicles at the same voltage. For this reason, there is a problem that the charging system is large.

Also, there is a problem in a power supply constituting the charging system that efficiency declines due to influence of a fixed loss at the time of a low load where an output current is small. This problem cannot be avoided even in a power supply that is designed to maintain high efficiency against a change in the output load to be connected.

FIG. 12 indicates an example of a charging system in a related art. A charging system 1001 has a power supply unit 1003 including a power supply circuit which receives a supply of an electric power from an alternating current power source 1002, and converts it into a direct-current power. In an electric power output unit 1008, direct-current power which has been generated in the power supply unit 1003 is supplied to a secondary battery 1009 connected to the charging system 1001.

FIG. 14 indicates an example of a load dependence property of a conversion efficiency in a power supply circuit in a related art. As shown in FIG. 14, the conversion efficiency declines in an area of a small output current. That is, although the conversion efficiency exceeds 95 percent when a load is large (range-1), the conversion efficiency falls to 92 percent when the load becomes small (range-2).

FIG. 13 indicates a charging current profile (A) and a voltage profile (B) of a secondary battery in a related art. As shown in FIG. 13, the charging current (A) of a secondary battery keeps the maximum value for a fixed period at the time of an early stage, and then decreases with drawing a gentle parabolic curve. On the other hand, although the charging voltage (B) is less than a rated voltage at the time of the early stage, its value increases with time, and after the supply current value has descended, it reaches to appropriately the rated voltage.

For this reason, even if output power capacity of a charging system is as much as 50 kilowatts, the largest capacity is required within 10 minutes from the beginning of charge ((1) at the time of outputting 50 kilowatts in FIG. 13), and the largest power is unnecessary after that ((2) at the time of outputting 25 kilowatts in FIG. 13).

That is, the largest capacity provided in the charging system is utilized only in the early stage of charge, and only a small amount of current supply is needed during the remaining period, i.e. half or more of the charging period. In this remaining period, the power supply efficiency is also lower than that of the time of the maximum output, and a percentage of conversion to heat from electric power becomes large as in the case with the charging system of the related art shown in FIG. 12. Further, in order to maintain the charge efficiency high against the change in the load, large components are needed in the configuration of the power supply, and thus the number of parts increases. These factors disturb miniaturizing the power supply apparatus.

The present invention has been made in view of the points mentioned above, and the object is to provide a small-sized charging system and a charging method in which the efficiency of the power supply unit of the charging system is controlled.

### Means for Solving the Problems

A charging system according to the present invention includes: an output means for supplying electric power; a plurality of electric power generating means for generating electric power of a predetermined power value; a detection means for detecting a state of the output means; and a control means for controlling the plurality of electric power generating means based on the state detected by the detection means.

A charging method according to the present invention is a charging method that performs charging by electric power supplied from at least one of a plurality of electric power generating means to an output means. The charging method includes: a step of detecting a state of the output means; and a step of controlling the plurality of electric power generating means based on the detected state.

### Advantage of the Invention

According to the present invention, because a charging system has a configuration in which a power supply unit of the charging system has a plurality of electric power generating means, and an electric power route can be changed, the charging system always operates in the state of the largest efficiency and the largest output.

### BRIEF DESCRIPTION OF THE DRAWINGS

FIG. 1 is a block diagram showing an example of a configuration of a charging system according to a first exemplary embodiment of the present invention.

FIG. 2 is a diagram showing an example of an electric current profile of a secondary battery connected to a charging system according to the first exemplary embodiment of the present invention.

FIG. 3 is a diagram showing an example of a procedure of a charging method according to the first exemplary embodiment of the present invention.

FIG. 4 is a block diagram showing an example of a configuration of a charging system according to a second exemplary embodiment of the present invention.

FIG. 5 is a diagram showing an example of a procedure to determine a power supply circuit which operates in a charging system according to the second exemplary embodiment of the present invention.

FIG. 6 is a block diagram showing an example of a configuration of a charging system according to a third exemplary embodiment of the present invention.

FIG. 7 is a diagram showing an example of a procedure of a charging method according to the third exemplary embodiment of the present invention.

FIG. 8 is a block diagram showing one example of a configuration at the time of performing a charging procedure of a charging system according to the third exemplary embodiment of the present invention.

FIG. 9 is a block diagram showing another example of a configuration at the time of performing a charging procedure of a charging system according to the third exemplary embodiment of the present invention.

FIG. 10 is a block diagram showing an example of a configuration of a charging system according to a fourth exemplary embodiment of the present invention.

FIG. 11 is a diagram showing an example of a procedure to determine a power supply circuit assigned in a charging system according to the fourth exemplary embodiment of the present invention.

FIG. 12 is a block diagram showing a configuration of a charging system of a related art.

FIG. 13 is a diagram showing an example of a charging current profile and a voltage profile of a secondary battery in a related art.

FIG. 14 is a diagram showing an example of a load dependence property of conversion efficiency in a power supply circuit in a related art.

### BEST MODE FOR CARRYING OUT THE INVENTION

Exemplary embodiments of the present invention will be described based on drawings. However, the present invention is not limited to the exemplary embodiments indicated below.

### First Exemplary Embodiment

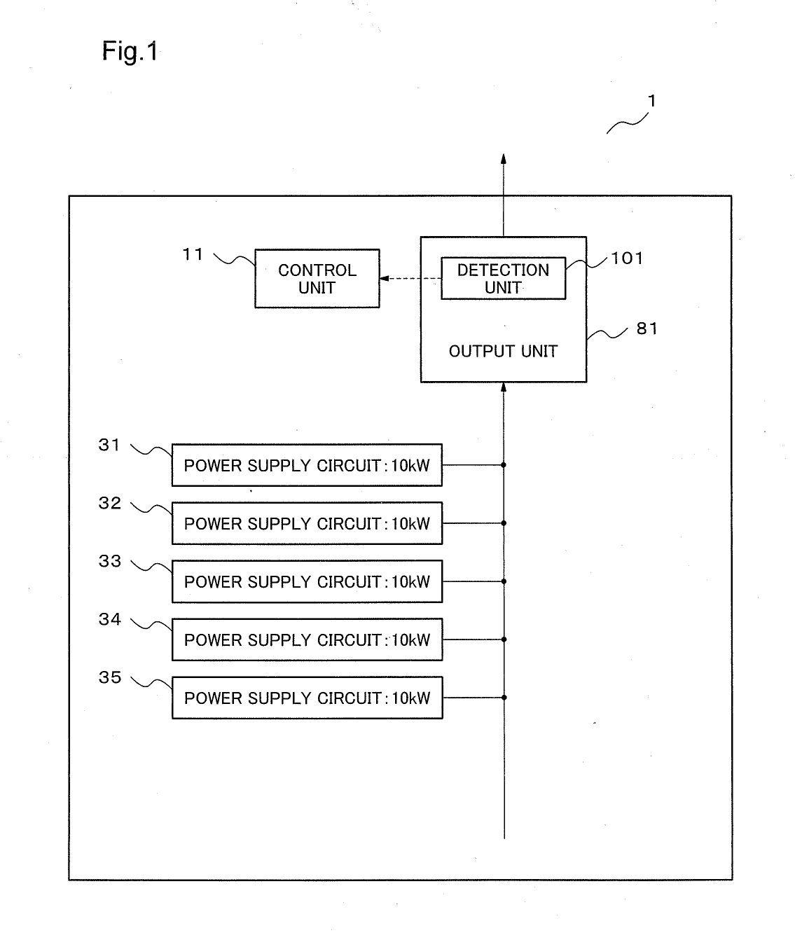

FIG. 1 is a block diagram showing a configuration of an example of a charging system according to the first exemplary embodiment of the present invention.

In a charging system 1 according to this exemplary embodiment, a plurality of power supply circuits 31 to 35 supply electric power to an output unit 81 to which a secondary battery is connected. Meanwhile, in drawings attached to the present description, an arrow in a solid line represents electric power to be supplied, and an arrow in a dotted line represents transmission of information such as a detection signal and a control signal between components. An operation of each of the power supply circuits 31 to 35 is controlled by a control unit 11. A detection unit 101 is provided in the output unit 81. The detection unit 101 detects information on a secondary battery to be connected, and transmits the information to the control unit 11.

Each of the power supply circuits 31 to 35 receives alternating current power from a business or home alternating current source, and generates direct-current power of a predetermined voltage. A load dependence of conversion efficiency of a power supply circuit according to this exemplary embodiment is the same as a load dependence of the related art shown in FIG. 14.

Meanwhile, although the number of power supply circuits is five in FIG. 1, the number is not limited to this. That is, the number of the power supply circuit may be less than five or may be more than five. In this exemplary embodiment, the maximum output of all of the five power supply circuits is set to 10 kilowatts.

As equipment, on which a secondary battery connected to the output unit of a charging system according to this exemplary embodiment, is mounted, an information terminal such as a personal computer and mobile equipment such as an electric vehicle and a bicycle are mentioned. The secondary batteries of various rated voltage values are used for such apparatus. The rated voltage value ranges very widely, for example, from 10 volts to more than 300 volts. The rated capacity of secondary battery ranges also very widely, for example, from several kilowatts to more than 30 kilowatts. In addition, various materials are used for the secondary battery. For example, there are a secondary battery mounted onto a mobile information communication apparatus for a multimedia use and a secondary battery loaded into an electric vehicle for the purpose of the environment harmony. Regarding the material of the secondary battery, there are a metallic lithium battery and a polymer lithium battery as a lithium system secondary battery. Also, as an alkaline secondary battery, there are a nickel-hydride battery and a nickel cadmium battery.

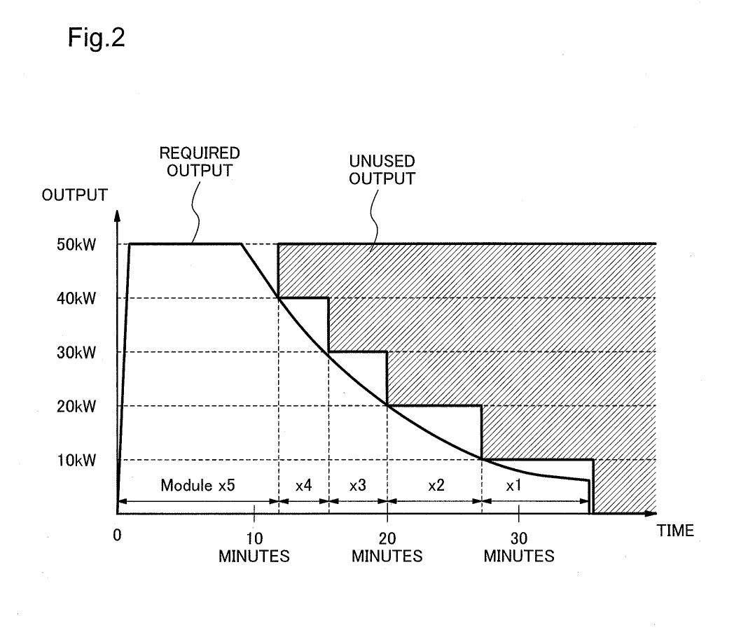

FIG. 2 indicates a charging profile of the output required by the secondary battery to the charging system according to this exemplary embodiment. Because the charging system 1 according to this exemplary embodiment has five power supply circuits of the maximum output of 10 kilowatts, the maximum output of the charging system 1 is 50 kilowatts.

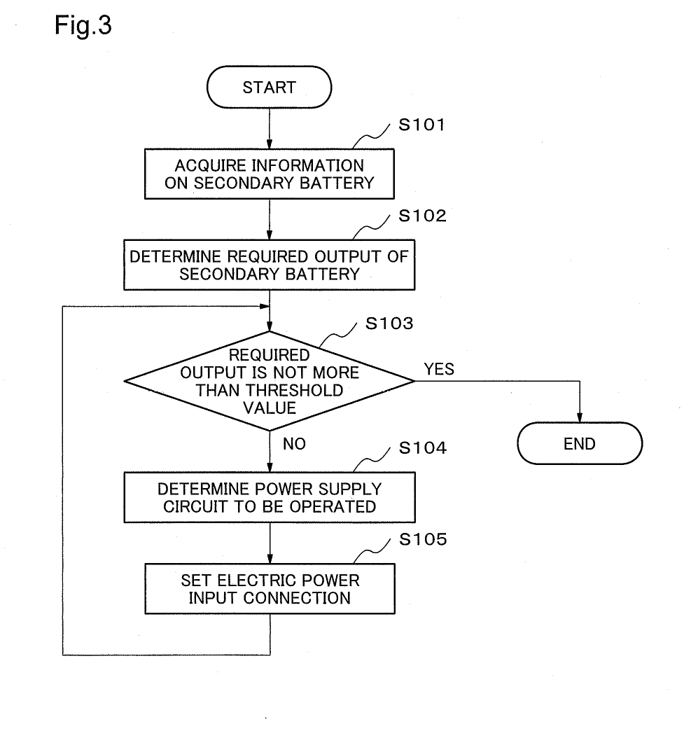

With reference to FIGS. 2 and 3, a procedure for connecting a secondary battery of a remaining battery amount of approximately zero percent to this charging system 1, and charging the battery, will be described.

The detection unit 101 acquires information on the secondary battery (Step S101). The detection unit 101 detects a voltage value between two electrodes of the secondary battery and a current value that flows from the secondary battery to a terminal of the output unit 81. The remaining charge amount of the secondary battery is determined by the voltage value and the current value.

Further, the detection unit 101 may determine the kind of a secondary battery because a charging profile may be different according to the material of which a secondary battery is formed. For example, the kind of the secondary battery may be distinguished automatically by a shape of the electrode of the secondary battery, or a user may input the kind of the secondary battery to the control unit 11 in advance. Also, the kinds of secondary batteries may be limited, and the kinds of secondary batteries, which can be charged, are indicated on the outside of the charging system 1.

According to the information which the detection unit 101 has acquired, the control unit 11 determines an output that the secondary battery requires to the charging system 1 (Step S102). For example, the control unit 11 stores the charging profile of the secondary battery and a relationship between a voltage value and a current value in a memory unit, which is not illustrated, and obtains a required output with reference to the relationship.

Next, whether the required output value is less than or equal to a predetermined threshold value or not is determined (Step S103). When the required output value is less than or equal to the threshold value, the charging procedure ends, because the secondary battery does not need to be charged. Meanwhile, the threshold value may differ depending on the kind or the size of the secondary battery. The threshold value is set based on a result that the detection unit 101 has determined the kind of the secondary battery.

When the charging procedure of the secondary battery is continued, power supply circuits to be operated among the five power supply circuits 31 to 35 are determined based on the required output of the secondary battery having been determined as above (Step S104). In this exemplary embodiment, because each of the five power supply circuits 31 to 35 has the maximum output of 10 kilowatts, a number obtained by adding one to quotient calculated by dividing the required output value by 10 kilowatts is the number of power supply circuits to be operated. However, the number of power supply circuits to be operated does not exceed five. That is, the number of power supply circuits is determined such that, except for a case where the output requested by the secondary battery is larger than the maximum output when all of the five power supply circuits operate, a minimum number of power supply circuits operate such that the sum of the maximum output of the operating power supply circuits may not be less than the required output.

The power supply circuit to be operated may be any one among the five power supply circuits, and may be selected by a predetermined method. For example, they may be selected such that the power supply circuit 31 has the highest operating ratio, and the power supply circuit 35 has the lowest operating ratio. Also, each of the operating ratios of the power supply circuits 31 to 35 may be changed for each charging procedure. For example, the operating ratio may be cyclically allocated among the power supply circuits 31 to 35 such that, after the power supply circuit 31 has finished a charging procedure with the highest operating ratio, the power supply circuit 32 has the highest operating ratio and the power supply circuit 31 has the lowest operating ratio in the next charging procedure.

When the power supply circuits to be operated have been determined, the electric power input connection is set in order to control the respective operations of the power supply circuits 31 to 35 (Step S105). For example, an operation of a power supply circuit which will not operate may be suspended, or a power supply path may be cut so that a supply of electric power to a power supply circuit not to be operated may be suspended.

The detection unit 101 detects information on the secondary battery at a predetermined timing. The state of the secondary battery, for which the charging procedure is performed, changes with time. That is, as shown in FIG. 2, when a remaining charge amount of a secondary battery increases along with a progress of the charging procedure, the output required to the charging system by the secondary battery decreases. By changing the number of power supply circuits to be operated corresponding to the change, the power consumption that does not contribute to the charging procedure of the secondary battery can be suppressed.

As shown in FIG. 2, in the early charging stage of the time zone from zero to 10 minutes, the charging system 1 operates in a constant current mode where the current value is the largest. In this time zone, the output unit 81 supplies electric power of the maximum output of 50 kilowatts to the secondary battery by the electric power supplied from the power supply circuits 31 to 35. Referring to a load factor dependence of a power supply efficiency shown in FIG. 14, the load factor in the charging system 1 is high and the power supply circuits 31 to 35 operate in a highly efficient state.

When 10 minutes have passed from the start of charging, a current value of the output supplied to the secondary battery gradually decreases, indicating an electric current profile like a parabolic curve as shown in FIG. 2. Accordingly, the maximum output of 50 kilowatts becomes unnecessary. The charging system 1, according to this exemplary embodiment, reduces the number of the power supply circuits to be operated among five power supply circuits, according to the decrease of the output value. For example, the control unit 11 controls a supply of electric power to each of the power supply circuits 31 to 35. As a result, the output of the charging system 1 decreases from 50 kilowatts (five), 40 kilowatts (four), 30 kilowatts (three) and 20 kilowatts (two), successively. In this charging procedure, each of the power supply circuits 31 to 35 operates with the largest electric power of approximately 10 kilowatts and with the largest efficiency in the operating state.

When the required output is detected to be not more than a predetermined threshold value, the operation of all power supply circuits stops, and the charging procedure is completed. This threshold value may be a predetermined value dependent on the kind of the secondary battery, or may be changed by a request from a user who wants to finish a charging procedure in a short time.

A part of the supplied electric power, which is not outputted for charging the secondary battery, is converted into heat, and is discharged from a power supply circuit inside the apparatus. For this reason, a component for handling heat radiation is required to the power supply apparatus.

As a result of the above-mentioned procedure, in the charging system 1 according to the exemplary embodiment, generation of heat discharged inside the power supply apparatus due to the decline of the conversion efficiency of the apparatus is suppressed. As a result, the size of the component for heat radiation can be suppressed.

In addition, in the above-mentioned example, although the operation of the power supply circuit has been suspended according to the decrease of a current value at the time of charging, the output of this power supply circuit may be diverted to others as an unused output shown in FIG. 2 without suspending the operation of the power supply circuit. That is, it is possible to change a supply destination of the output power of the power supply circuit to a different output unit, and to assign it for charging another secondary battery. As a result, the operation of the power supply circuit is maintained at high conversion efficiency, and a waiting time required for charging a plurality of secondary batteries is reduced. Even when two or more electric vehicles visit in the charging system, the charging procedure is smoothly performed.

### Second Exemplary Embodiment

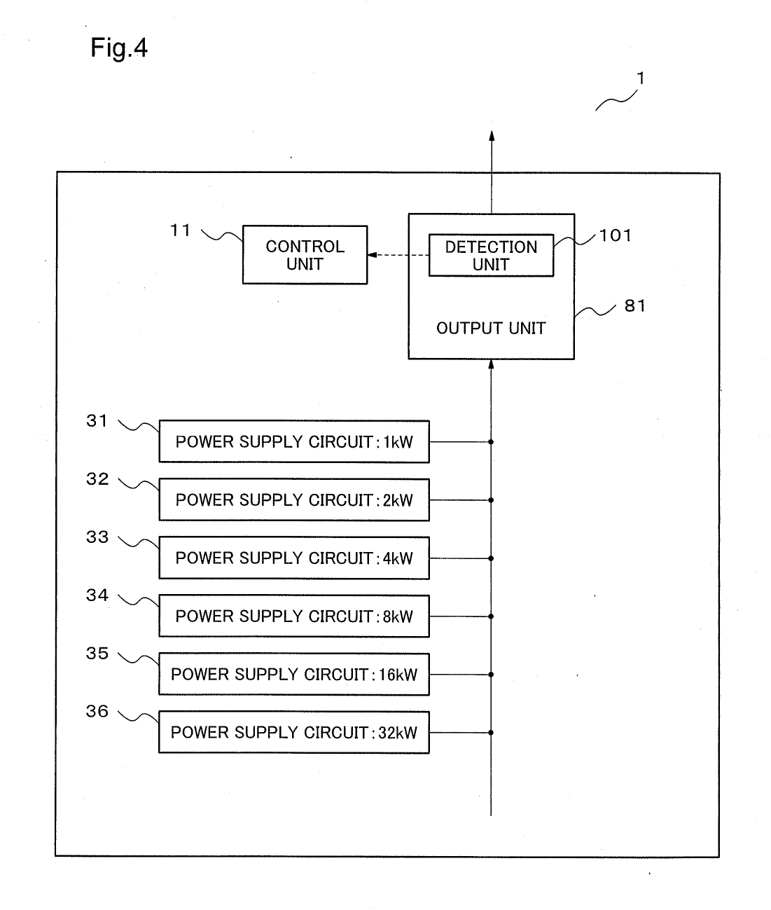

FIG. 4 is a block diagram showing a configuration of a charging system 1 according to the second exemplary embodiment of the present invention. In this exemplary embodiment, the charging system 1 includes six power supply circuits having the maximum output of 1 kilowatt, 2 kilowatts, 4 kilowatts, 8 kilowatts, 16 kilowatts and 32 kilowatts, respectively. As a result of adding up these outputs, the maximum output of the charging system 1 is 63 kilowatts.

Because the other components are identical to the first exemplary embodiment, description will be omitted.

In this regard, however, a procedure to determine power supply circuits to be operated from output required by a secondary battery to the charging system 1 is different from the procedure according to the first exemplary embodiment (Step S104 of FIG. 3). Hereinafter, the procedure to determine the power supply circuits will be described.

With reference to FIG. 4, it is assumed that a power supply circuit having the maximum output of 1 kilowatt is a power supply circuit 31, a power supply circuit of the maximum output of 2 kilowatts a power supply circuit 32, a power supply circuit of the maximum output of 4 kilowatts a power supply circuit 33, a power supply circuit of the maximum output of 8 kilowatts a power supply circuit 34, a power supply circuit of the maximum output of 16 kilowatts a power supply circuit 35 and a power supply circuit of the maximum output of 32 kilowatts a power supply circuit 36. It is assumed that the output required for the secondary battery is Q, and the smallest integer that is larger than Q is L.

When the quotient obtained by dividing L by 32 is one, a numerical value obtained by subtracting 32 from L is substituted for L, and the power supply circuit 36 is operated. When the quotient is zero, the numerical value of L is stored, and the power supply circuit 36 is not operated.

Next, when the quotient obtained by dividing L by 16 is one, a numerical value obtained by subtracting 16 from L is substituted for L, and the power supply circuit 35 is operated. When the quotient is zero, the numerical value of L is stored, and the power supply circuit 35 is not operated.

Hereinafter, when, by repeating this processing, the numerical value of L becomes zero, the procedure for determining power supply circuits to be operated ends.

The charging system 1 according to the second exemplary embodiment is generalized as a combination in which (r−1) power supply circuits, each having maximum output of r^{k}P are included (k is an integer of no smaller than zero). In order to increase the maximum output value of the charging system 1 including power supply circuits whose maximum output values are restricted by increasing the number of the power supply circuits, r should be made not less than three.

Here, r^{k} represents r raised to the k-th power, and P is the maximum output value of a power supply circuit having the smallest maximum output value among the power supply circuits included in the charging system 1. In addition, r is an integer of no smaller than two, and k is an integer of no smaller than zero and no more than n. Along the lines of the above-mentioned example, it is assumed that a maximum output value of the power supply circuit included in this charging system 1 is P multiplied by r^{k}. The charging system 1 shown in FIG. 4 is a combination of power supply circuits when r is two, n is five and P is 1 kilowatt. The maximum output value of the charging system 1 is the sum of (r−1)r^{k}P about k, that is, (rⁿ⁺¹−1)P.

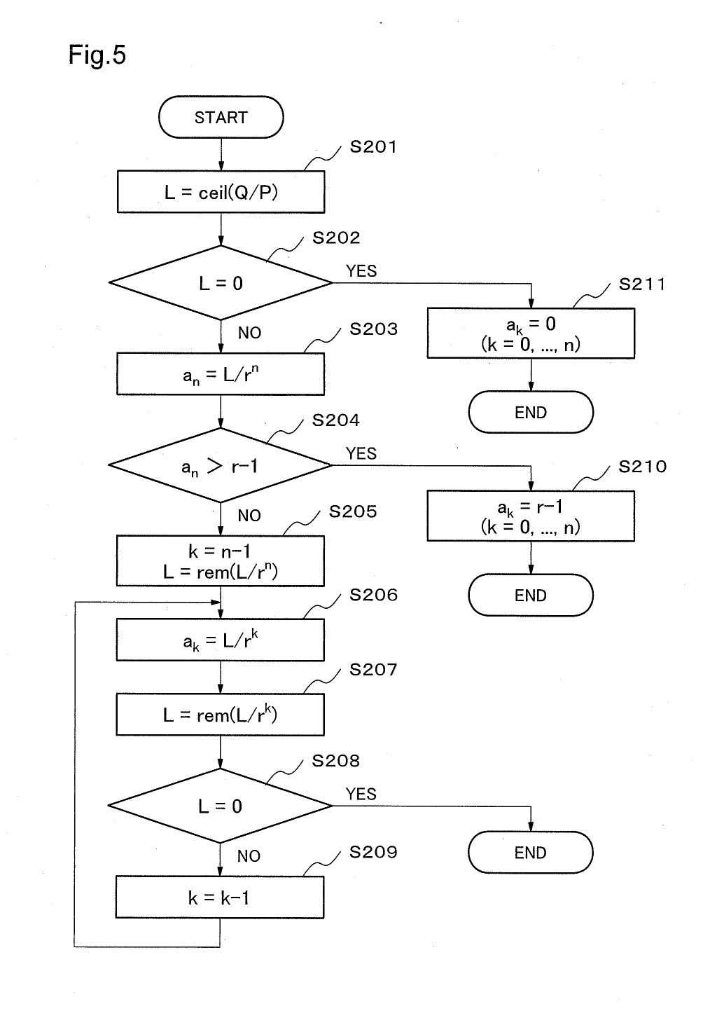

The determination procedure of power supply circuits in a generalized combination of power supply circuits will be described with reference to FIG. 5.

First, the quotient is obtained by dividing the output Q required by the secondary battery by P, and let the smallest integer of not less than the value of this quotient be L (Step S201). L is obtained as a ceiling function (ceil (Q/P)) that takes the quotient obtained by dividing Q by P as an argument.

Here, if L is zero (Step S202), a power supply circuit is not operated. That is, aₖ is made to be zero for all k (Step S211), and the procedure is finished.

Next, given that the number of power supply circuits to be operated among power supply circuits having a maximum output r^{k}P is aₖ, aₖ is a quotient which is obtained by dividing L by r^{k} (Step S206). After obtaining this aₖ, let the remainder (rem (L/r^{k})) obtained by dividing L by r^{k} be L (Step S207).

When the number aₙ of power supply circuits to be operated among power supply circuits having the largest maximum output value is obtained (Step S203), if a quotient obtained by dividing L by rⁿ is larger than r (Step S204), the output required by the secondary battery to the charging system 1 exceeds the maximum output value of the charging system 1. The charging system 1 operates all the power supply circuits, and charges the secondary battery by the maximum output value of the charging system 1. That is, aₖ for every k is set to r−1, and the procedure is finished (Step S210).

Hereinafter, such processing is repeated, and the procedure of determining power supply circuits to be operated is finished when a numerical value of L becomes zero (Step S208).

Meanwhile, when aₖ is not less than one and is less than r−1, aₖ power supply circuits is selected from r−1 power supply circuits having the maximum output power of r^{k}P according to a predetermined policy.

In addition, by inserting a determination process in FIG. 5 according to need, the procedure of determination of power supply circuits to be operated may be finished.

Meanwhile, although, in this exemplary embodiment, power supply circuits to be operated are determined following the procedure shown in FIG. 5, information on correspondence between a value of the required power and operations of the respective power supply circuits may be stored in a memory unit which is not illustrated. In such configuration, based on a required power value of the secondary battery, the information on power supply circuits is referred to. That is, the reference processing to the memory unit is replaced by the processing of step 202 or later.

The charging system 1 according to this exemplary embodiment has a feature that a total of the power supply circuits 31 to 36 is set in units of 1 kilowatt. In the charging system 1 according to this exemplary embodiment, the conversion efficiency of the power supply is maintained in a state higher than that of the first exemplary embodiment. For this reason, the output power corresponds finely to the state of the secondary battery to be charged, loss due to decrease of the conversion efficiency is suppressed low, and the charging system 1 operates with a less power consumption.

### Third Exemplary Embodiment

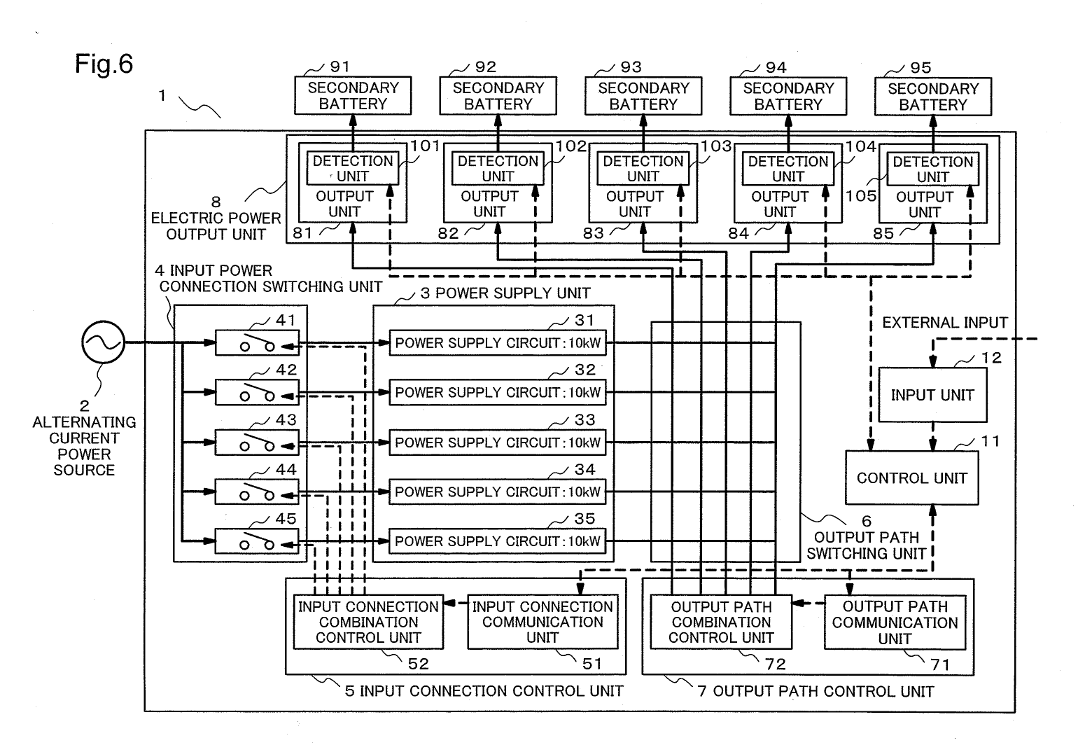

FIG. 6 is a block diagram showing a configuration of a charging system 1 according to the third exemplary embodiment of the present invention.

The charging system 1 according to this exemplary embodiment includes an electric power output unit 8 having a plurality of output units which supply direct-current power to secondary batteries so that a plurality of secondary batteries can be charged, simultaneously. Meanwhile, although the number of output units is set to be five in this exemplary embodiment, it is not limited to this, and the number of the output units should be not less than two.

Detection units 101, 102, 103, 104 and 105 are provided in the output units 81, 82, 83, 84 and 85, respectively. Because each of the detection units 101 to 105 is identical to the detection unit 101 in the first exemplary embodiment, description will be omitted.

The charging system 1 includes a power supply unit 3 having a plurality of power supply circuits which generate direct-current power. Because the plurality of power supply circuits in this exemplary embodiment have the configuration identical to the power supply circuits 31 to 35 in the first exemplary embodiment, description will be omitted. Meanwhile, although the number of the power supply circuits is made five in this exemplary embodiment, it is not limited to this and the number of the power supply circuits should be no smaller than two. Although the number of the power supply circuits and the number of the output units are the same in this exemplary embodiment, they may be different from each other. In this exemplary embodiment, it is assumed that all the power supply circuits have an identical maximum output value of 10 kilowatts, for example.

The charging system 1 according to this exemplary embodiment is connected to an external alternating current power source 2, and secondary batteries 91 to 95 are connected to the charging system 1. Meanwhile, in FIG. 6, although a secondary battery is connected to each of all the output units 81 to 85, the number of secondary batteries to be charged should be no smaller than one.

The charging system 1 receives alternating current power from the alternating current power source 2, and charges the secondary batteries by supplying direct-current power to the secondary batteries. The power supply unit 3 generates direct-current power having an output current value enough for charging one secondary battery connected to the output unit.

The charging system 1 includes an input power connection switching unit 4 which supplies alternating current power received from the alternating current power source 2 to each of the power supply circuits 31 to 35. The input power connection switching unit 4 has switches 41, 42, 43, 44 and 45 connected to the power supply circuits 31, 32, 33, 34 and 35, respectively. The switches 41 to 45 supply alternating current power to each of the power supply circuits 31 to 35 and separate from the alternating current power source 2. The switches 41 to 45 may be realized by a unit which changes a connection physically such as a relay, or may be realized by a switching element such as a transistor which performs a switching operation between an electric conductive state and a non-conductive state.

The control unit 11 acquires information on the secondary battery from the detection unit to which the secondary battery is connected, as in the case of the first exemplary embodiment. That is, the control unit 11 obtains a remaining charge amount of the secondary battery based on a voltage between electrodes of the secondary battery and a current value that flows to the electrode. The control unit 11 acquires information on the kinds of secondary batteries, such as the material of which the secondary battery is composed, from the detection unit. Alternatively, information on the kind of the secondary battery may be inputted to an input unit 12 by a user from outside.

A plurality of secondary batteries are connected to the charging system 1 according to this exemplary embodiment. Accordingly, in addition to the operations in the first exemplary embodiment, the control unit 11 acquires the number of the secondary batteries. That is, although each of the detection units 101 to 105 notifies the control unit 11 of information on the secondary batteries 91 to 95 that are connected, when a secondary battery is not connected, information that indicates there is no load on the output unit is transmitted to the control unit 11. The control unit 11 prepares a set of charge processing information based on information on the number of secondary batteries acquired from the detection units 101 to 105. The number of such sets is the number of the secondary batteries to be connected. When a secondary battery is connected newly, a set of charge processing information is added. Charge processing information is updated by instructions of the control unit 11 at a time when the detection units 101 to 105 detect a state of the secondary battery, and transmit it to the control unit 11.

Further, in a case where a plurality of secondary batteries are charged, the input unit 12 inputs an order of priority of charging of the secondary batteries and notifies the control unit 11 of it. The control unit 11 controls charge processing information based on the order of priority. The order of priority may be changed by a user's operation during the charging procedure.

The control unit 11 may calculate a time until charge completion based on the charge processing information, and notify the user of the charging time by indicating it on a display unit which is not illustrated. The user may refer to the indicated charging time and input, to the input unit 12, instructions for interruption of the charging procedure of the connected secondary battery if the user needs.

The switches 41 to 45 of the input power connection switching unit 4 are controlled by an input connection control unit 5 which has received instructions from the control unit 11. An input connection combination control unit 52 included in the input connection control unit 5 receives the instructions from the control unit 11 via an input connection communication unit 51, and changes a switch that is connected to the power supply circuit, which has been designated by the control unit 11 as a power supply circuit to be operated, into a closed-state, for example, and supplies electric power from the external alternating current power source 2. Also, the input connection combination control unit 52 changes a switch that is connected to the power supply circuit, which has been designated by the control unit 11 as a power supply circuit not to be operated, into an opened state to cut off supply of electric power from outside.

The charging system 1 according to this exemplary embodiment connects a plurality of secondary batteries, and supplies direct-current power from the power supply circuit to the respective secondary batteries. For this reason, electric power, which the power supply circuits 31 to 35 supplies, needs to be allocated to each of the plurality of output units 81. In this exemplary embodiment, an output path switching unit 6 having a bus configuration is provided between the output side of the power supply unit 3 and the input side of the electric power output unit 8. That is, the output path switching unit 6 is configured so that each output of the power supply circuits 31 to 35 provided in the power supply unit 3 can be connected to all inputs to the output units 81 to 85 provided in the electric power output unit 8 via a switch or the like. The switch of the output path switching unit 6 is controlled by an output path combination control unit 72 which has received instructions from the control unit 11 via an output path communication unit 71.

That is, for example, the output path combination control unit 72 changes only a switch to an input line to the output unit 81 among the switches of the bus line connected to the output of the power supply circuit 31 into the closed-state so that direct-current power, which the power supply circuit 31 generates, may be supplied to the output unit 81.

The output path switching unit 6 sets a route of electric power supply from the power supply unit 3 to the electric power output unit 8. That is, a path from direct-current power generated in each of the power supply circuits 31 to 35 included in the power supply unit 3 to one of the output units 81 to 85 included in the electric power output unit 8 is set. The output path switching unit 6 is controlled by an output path control unit 7. That is, a supply route of direct-current power is set appropriately according to the state of the output units 81 to 85 of the electric power output unit 8, for example,

the state including a remaining amount of a secondary battery connected to an output unit and the number of the secondary batteries connected to the electric power output unit 8 or the like.

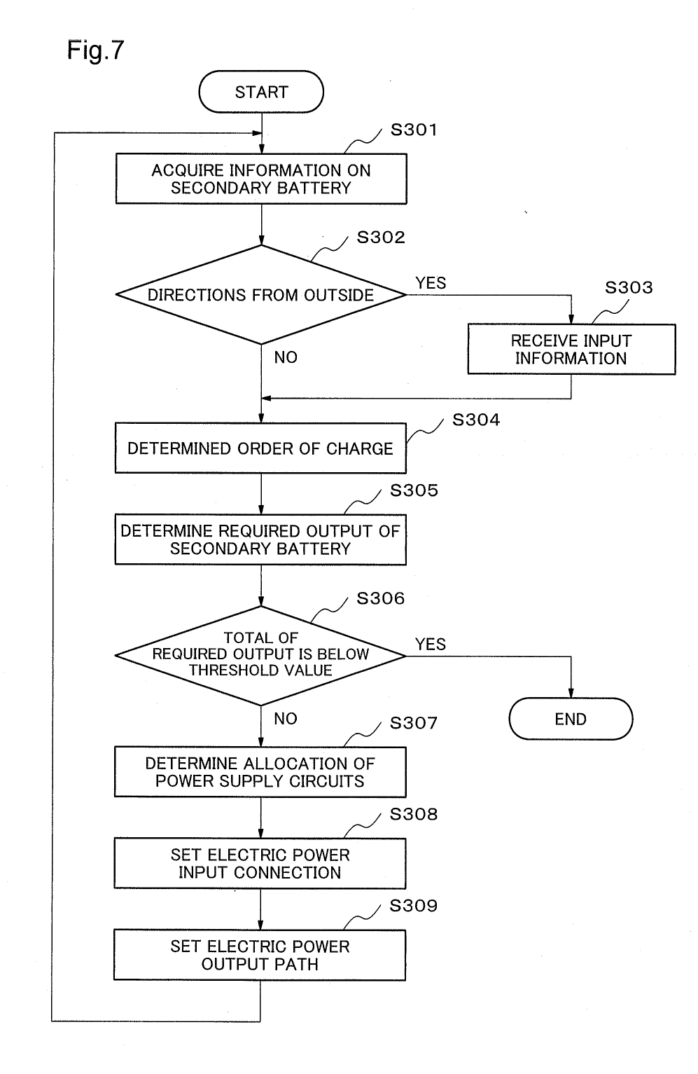

Next, with reference to FIGS. 6 and 7, details of a control procedure of the output power in the charging system 1 according to the third exemplary embodiment will be described below.

When secondary batteries are connected to at least one of the output units 81 to 85 of the electric power output unit 8, the charging procedure begins.

The detection units 101 to 105 acquire information on the secondary battery connected to each of the output units 81 to 85 (Step S301). Information, which each of the detection units 101 to 105 detects, includes, for example, presence or absence of a secondary battery. When a secondary battery is connected, such information may include a voltage value between electrodes of the secondary battery and a current value which flows to a terminal of an output unit from the secondary battery. Further, the detection units 101 to 105 may distinguish the kind of the secondary battery by the shape and the like of the electrode of the secondary battery. The information is transmitted to the control unit 11, and the number of secondary batteries and remaining charge amounts of the respective secondary batteries and the kinds of the secondary batteries are determined.

In order to determine the remaining charge amount and the kind of the secondary battery from information detected by the detection unit, the control unit 11 may refer to corresponding information which is stored in a memory unit that is not illustrated.

Next, it is detected whether an instruction is inputted from outside to the input unit 12 (Step S302). When there is an instruction from outside, the control unit 11 receives the inputted information from the input unit 12 (Step S303).

When a plurality of secondary batteries are connected to the electric power output unit 8, an order of priority of a charging procedure of the plurality of secondary batteries is determined (Step S304). The order of priority may be set in advance, or it may be decided according to the instructions inputted from outside to the input unit 12.

The order of priority may be determined according to a state of the secondary battery, such as a remaining charge amount, or electric power may be supplied equally without giving priority to any secondary battery. The user may designate a secondary battery to be charged preferentially. When the order of priority is determined according to the remaining charge amount, the order may be decided so that a priority is given to one having a less remaining charge amount, and the secondary batteries connected may finish charging almost simultaneously, or a charging procedure of a secondary battery having a large remaining charge amount, that is, one with a short charging time may be given priority.

Next, a required output of a secondary battery connected to the electric power output unit 8 is determined (Step S305). Meanwhile, Step S304 and Step S305 may be interchanged. The control unit 11 may refer, for example, to a charging profile of the secondary battery stored in the memory unit, and determine the required output.

It is determined whether the total of the required output values is less than a predetermined threshold value or not (Step S306), and when it is less than the threshold value, a charging procedure ends because any of the secondary batteries needs to be charged. The threshold value may be different depending on the kind or the size of the secondary battery. The threshold value is determined based on the information which the detection unit has detected.

When the charging procedure is continued, power supply circuits to be assigned to charging of respective secondary batteries are determined (Step S307). That is, based on the required output and the order of priority, at least one power supply circuit to be assigned to each of the secondary battery is selected from the power supply circuits 31 to 35.

When the allocation of the power supply circuits is determined, the control unit 11 notifies the input connection control unit 5 of instructions about the opened state or closed-state of each of the switches 41 to 45 of the input power connection switching unit 4 based on the allocation. As a result, an electric power input connection is set (Step S308).

Further, based on allocation of power supply circuits designating to which output unit of the output units 81 to 85 output of the power supply circuits 31 to 35 is supplied, a bus switch of the output path switching unit 6 is controlled by the output path control unit 7 that has received instructions from the control unit 11. As a result, an electric power output path is set (Step S309).

Next, a procedure for determining a power supply circuit to be assigned to each of the plurality of secondary batteries will be described giving an example.

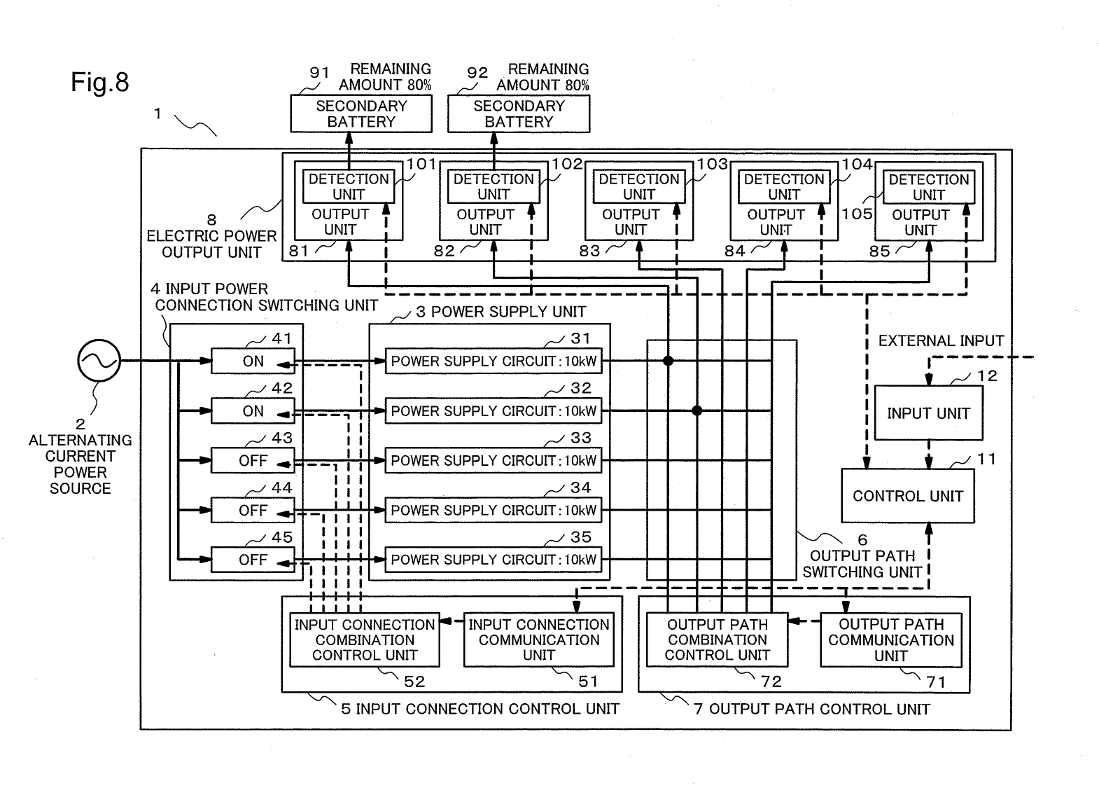

FIG. 8 indicates one example of a configuration, with which the charging system 1 according to this exemplary embodiment connects, and charges the secondary battery.

Two secondary batteries 91 and 92 are connected to the output unit 81 and 82, respectively, of the charging system 1. A remaining charge amount of the two secondary batteries 91 and 92 is assumed to be 80 percent. At that time, the respective required power values of the secondary batteries 91 and 92 are obtained based on a charging profile and is assumed to be less than 10 kilowatts, for example. One power supply circuit of 10 kilowatts should be assigned to each of the secondary batteries 91 and 92. The total of output, which the secondary batteries 91 and 92 require to the charging system 1, is a value smaller than the maximum output of the charging system 1, and in this case, is 20 kilowatts.

In the input power connection switching unit 4, the switches 41 and 42 are changed into the closed-state so that electric power from the alternating current power source 2 may be supplied to the power supply circuits 31 and 32, for example. The two power circuits may be selected by a predetermined method, as in the case of the first exemplary embodiment. Regarding the other power supply circuits 33 to 35, the switches 43 to 45 are changed into the opened state in the input power connection switching unit 4 and a supply of electric power from outside is cut off.

In the output path switching unit 6, the bus switch is set so that, for example, the output power of the power supply circuit 31 may be supplied to the output unit 81 to charge the secondary battery 91, and the output power of the power supply circuit 32 may be supplied to the output unit 82 to charge the secondary battery 92. That is, the switches of the positions indicated by a black circle in FIG. 8 will be in the closed-state, and an output of the power supply circuit conducts to an input of the output unit at this position.

In the configuration shown in FIG. 8, because only power supply circuits of a necessity minimum are operated when the plurality of secondary batteries 91 and 92 are connected to the charging system 1, the power supply unit 3 operates in an efficient state. That is, operations of the power supply circuits 33 to 35 that are not needed to be operated are stopped by changing the switches 43 to 45 in the input power connection switching unit 4 into the opened state. As a result, power consumption is reduced compared with the related technologies by which a power supply circuit operates in an inefficient state, and the plurality of secondary batteries 91 and 92 are charged efficiently.

In FIG. 8, when a secondary battery is connected to at least one of the output units 83 to 85 of an unconnected state, the power supply circuits 33 to 35, whose operations have been suspended, start to be used for charging the secondary battery by changing an input power connection. When a secondary battery has been connected to at least one of the output units 83 to 85, the detection units 103 to 105 detect the state, and information on the state is notified to the control unit 11. The input power connection is changed based on the notification.

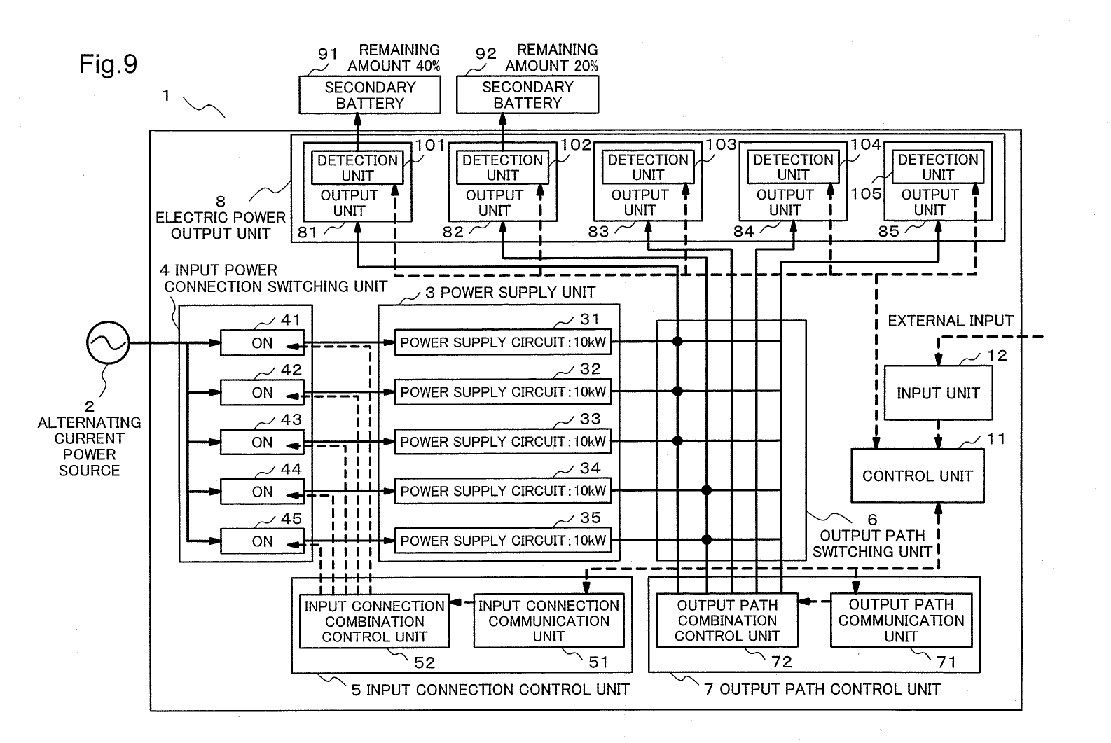

Next, another example of a configuration in which the charging system 1 according to this exemplary embodiment connects secondary batteries to charge is shown in FIG. 9.

The two secondary batteries 91 and 92 are connected to the output units 81 and 82 of the charging system 1, respectively. Remaining charge amount of the two secondary batteries 91 and 92 are set to 40 percent and 20 percent, respectively. At that time, it is assumed that the required power amounts of the secondary batteries 91 and 92 are 55 kilowatts and 80 kilowatts, respectively, for example.

As in the case of the first exemplary embodiment, the number of power supply circuits required to charge the secondary batteries 91 and 92 is three and four, respectively. At that time, because the number of power supply circuits for charging the secondary batteries 91 and 92 exceeds the number of power supply circuits provided in the charging system 1, restriction is needed for allocating the power supply circuits to be operated to the secondary battery.

The restriction may be decided in advance, or may be changed by a user at any time via the input unit 12. For example, it may be set so that, to a secondary battery of the least remaining charge amount, electric power required by the secondary battery is supplied, and when the required power is smaller than the maximum output power of the charging system 1, the surplus electric power is assigned to a secondary battery having the next smallest remaining charge amount. Alternatively, it may be set so that output power may be assigned preferentially to a secondary battery of the highest remaining charge amounts. Also, it may be set so that the output power may be assigned preferentially to a secondary battery designated by a user. Further, it may be set so that output power is assigned to be the connected secondary batteries equally. When the output power is assigned equally, the same number of power supply circuits, that is, two power supply circuits may be assigned to each of the secondary batteries shown in FIG. 9, for example. Alternatively, when there is a difference in remaining charge amounts, the number of the power supply circuits may be allocated so as to correlate with the electric power requested by the secondary batteries. For example, in FIG. 9, two and three power supply circuits may be assigned to the secondary batteries 91 and 91, respectively.

FIG. 9 indicates an example in which the output power is supplied to the secondary battery 91 preferentially, and the surplus output power is assigned to the secondary battery 92. Three power supply circuits are assigned to the secondary battery 91. Here, three power supply circuits are selected from the five power supply circuits shown in FIG. 9 according to a predetermined policy. For example, it is assumed that three power supply circuits of the power supply circuits 31 to 33 are assigned to the secondary battery 91. As shown in FIG. 9, the bus switch in the output path switching unit 6 is controlled so that an input of the output unit 81 may be conductive with outputs of the power supply circuits 31 to 33. A conducted position is indicated by a black circle.

Because three power supply circuits among the five power supply circuits of the charging system 1 have been assigned for charging the secondary battery 91, the surplus power supply circuits are two. Although allocation of four power supply circuits is required for charging the secondary battery 92, because power supply circuits capable of being allocated are two at this stage, the two power supply circuits are assigned to charge the secondary battery 92. That is, the bus switch of the output path switching unit 6 is controlled so that all the switches 41 to 45 of the input power connection switching unit 4 are changed into the closed-state, and all of the power supply circuits 31 to 35 operates, and the input of the output unit 82 may be conductive with the output of the power supply circuits 34 and 35. A conducted position is indicated by a black circle.

When a remaining charge amount has changed with time, the electric power which the secondary battery 91 requires has decreased, and surplus output power has increased, the increase may be assigned for charging a secondary battery which is being charged by output less than required output.

In the case where the number of the secondary batteries is not less than three, the same procedure as above is followed. That is, power supply circuits are assigned to two high priority secondary batteries, and when a surplus power supply circuit is available, the power supply circuit is assigned to the third secondary battery. It is also similar to the fourth secondary battery or later.

In the example shown in FIG. 9, when a total of the output required by the plurality of connected secondary batteries exceeds the maximum output power of the charging system 1, the charging procedures of the plurality of secondary batteries, which are designated with priority, are completed early. This order of priority can be changed by user's instructions at any time, and thus, it can be used for detailed use applications separately.

### Fourth Exemplary Embodiment

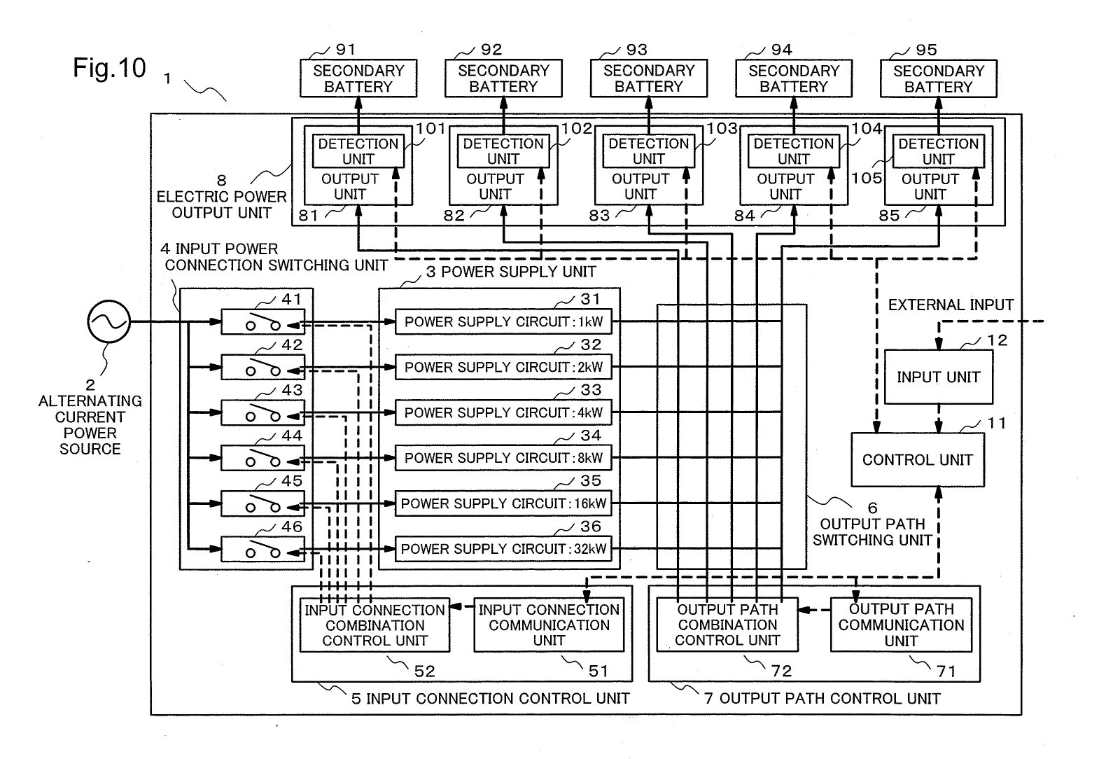

FIG. 10 is a block diagram showing a configuration of a charging system 1 according to the fourth exemplary embodiment of the present invention.

The charging system 1 according to this exemplary embodiment is different from the charging system according to the third exemplary embodiment in that the maximum output power of each of the power supply circuits 31 to 36 included in a power supply unit 3 is different from each other. Because the configurations of the charging system 1 according to this exemplary embodiment except for the above are identical to those of the third exemplary embodiment, description will be omitted. In this regard, however, a switch 46 is connected to a power supply circuit 36. Meanwhile, although the number of power supply circuits is 6 in this exemplary embodiment, it is not limited to this.

In FIG. 10, the maximum output power of the power supply circuits 31 to 36 is 1 kilowatt, 2 kilowatts, 4 kilowatts, 8 kilowatts, 16 kilowatts and 32 kilowatts, respectively. Adding these up, the maximum output of the charging system 1 is 63 kilowatts.

In this exemplary embodiment, when connecting a plurality of secondary batteries to the electric power output unit 8 to charge, a method to determine power supply circuits to be assigned to each of the secondary batteries is different from the third exemplary embodiment (Step S307 of FIG. 7).

A method to determine power supply circuits to be operated for one secondary battery is as it has been described in the second exemplary embodiment.

When the total of the required power of the plurality of secondary batteries is larger than the maximum output power of the charging system 1 and power supply circuits are assigned equally, a required power value of each of the secondary batteries is reduced so that the total of the required power of the plurality of secondary batteries may become equal to the maximum output power of the charging system 1. For the required power value which has been reduced, power supply circuits are assigned according to the following procedure.

In the case where the charging is performed giving an order of priority to the plurality of secondary batteries, the following procedure is followed.

Hereinafter, it is assumed that the number of switches of the input power switching unit 4 and the number of the power supply circuits of the power supply unit 3 is J, and the respective switches and power supply circuits are designated by j. It is assumed that the number of secondary batteries to be charged is M, and an output unit connected to the secondary battery is designated by m. Here, M does not exceed the number of output units of the electric power output unit 8.

As control instructions, of which the control unit 11 notifies the input connection control unit 5, it is assumed that one is substituted for Eⱼ, and the result is transmitted when switch j is changed into the closed-state, and zero is substituted for Eⱼ and the result is transmitted when changing switch j into the opened state.

As the control instructions, of which the control unit 11 notifies the output path control unit 7, it is assumed that one is substituted for Bⱼₘ, and the result is transmitted when an input of the output unit m is conductive with the output of the power supply circuit j, otherwise zero is substituted for Bⱼₘ and the result is transmitted.

Let a power value that the secondary battery m requests be Qₘ, and a maximum output value of the power supply circuit having the smallest maximum output value be P. Let the smallest integer that is not less than the value of a quotient obtained by dividing the power value Qₘ by P be Lₘ. Also, let the largest integer that is not more than the numerical value of a quotient obtained by dividing the maximum output value of the power supply circuit j by P be cⱼ. In this regard, however, let j and m be an integer of not smaller than 1.

A procedure for assigning power supply circuits for charging a plurality of secondary batteries is a procedure to obtain Bⱼₘ by solving, under restriction that the sum total of Lₘ about m does not exceed the sum total of cⱼ about j, J relations in which the sum total of Bⱼₘ about m is Eⱼ, that is, zero or one, and M relations in which the sum of products of Bⱼₘ and cⱼ about j is Lₘ.

For simplicity, as has been indicated in the second exemplary embodiment, the procedure for obtaining Bⱼₘ when the charging system is configured by power supply circuits in which cⱼ is expressed by exponentiation of r, r raised to the power of k, for example, that is, r^{k} (k is an integer of not less than zero) will be described. Meanwhile, given that the maximum value of k is n, J is (r−1)(n+1). Given that a quotient which is obtained by dividing j−1 by r−1 is k, cⱼ is r^{k}. Meanwhile, j=k(r−1)+1, k(r−1)+2, . . . , (k+1)(r−1). In the example of FIG. 10, r is two, n is five and P is 1 kilowatt.

Given that the number of the power supply circuits having the maximum output power of r^{k}P that are assigned to the secondary battery m is aₘₖ, aₘₖ is a total from k(r−1)+1 to (k+1)(r−1) about j of Bⱼₘ. aₖ of the second exemplary embodiment corresponds to aₗₖ of this exemplary embodiment.

Meanwhile, when aₘₖ power supply circuits are selected from the plurality of power supply circuits in which aₘₖ is not less than one and the maximum output power is r^{k}P, selection is made according to a predetermined policy, and Bⱼₘ is made one for the selected power supply circuits.

As a result, the procedure to obtain the above-mentioned Bⱼₘ is substituted by a procedure to obtain aₘₖ.

Hereinafter, it is assumed that power supply circuits are assigned so that the first secondary battery among the plurality of secondary batteries may be charged on a preferential basis. Because this procedure is performed following the procedure of FIG. 5 of the second exemplary embodiment, description will be omitted. Meanwhile, in FIG. 5, L, aₖ and aₙ are rewritten by Lₗ, aₗₖ and aₗₙ, respectively. After power supply circuits has been assigned for charging the first secondary battery, the power supply circuits are assigned for charging the second secondary battery, and after that, the power supply circuits are assigned in turn for charging the secondary batteries.

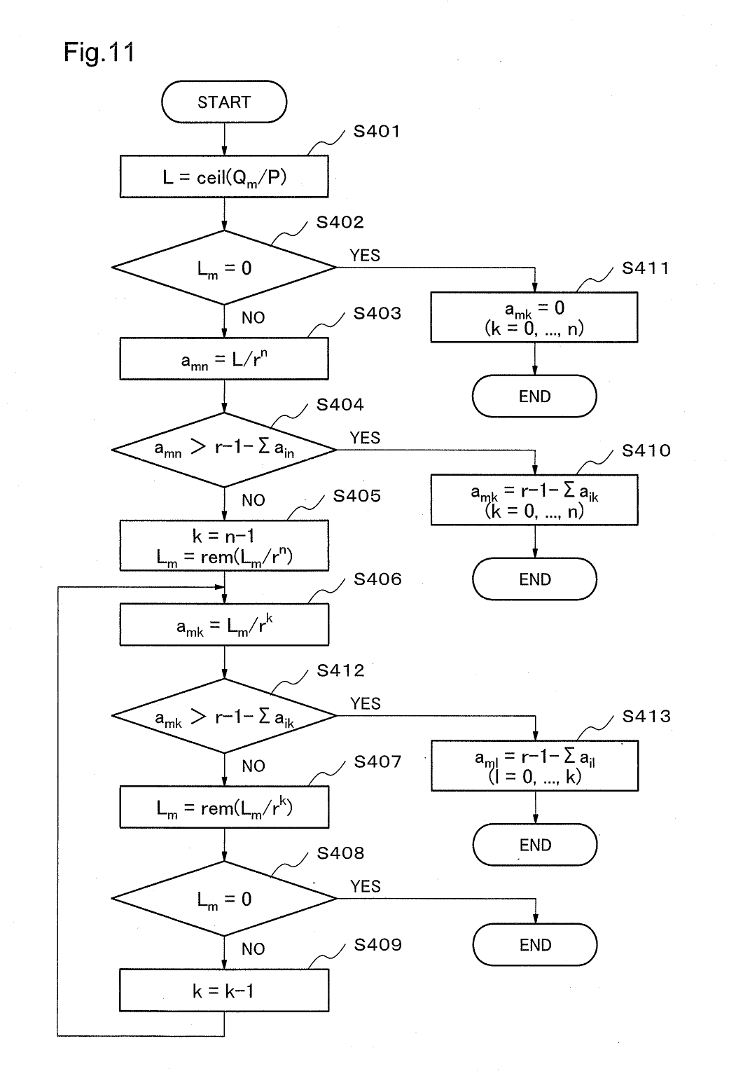

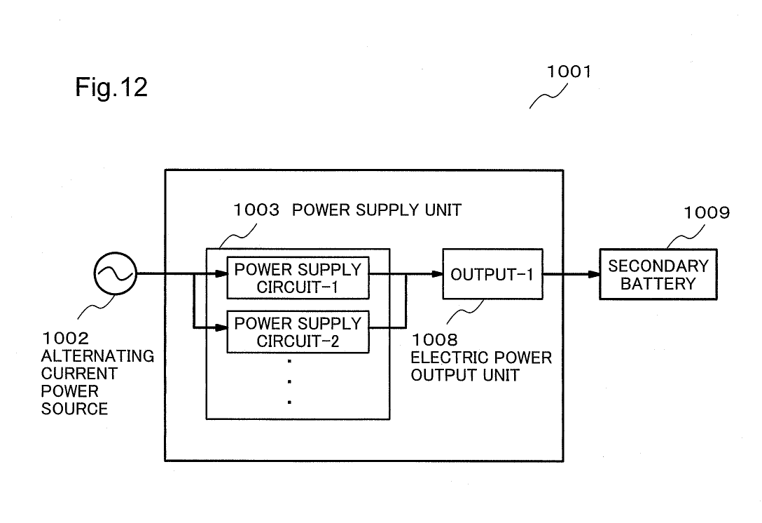

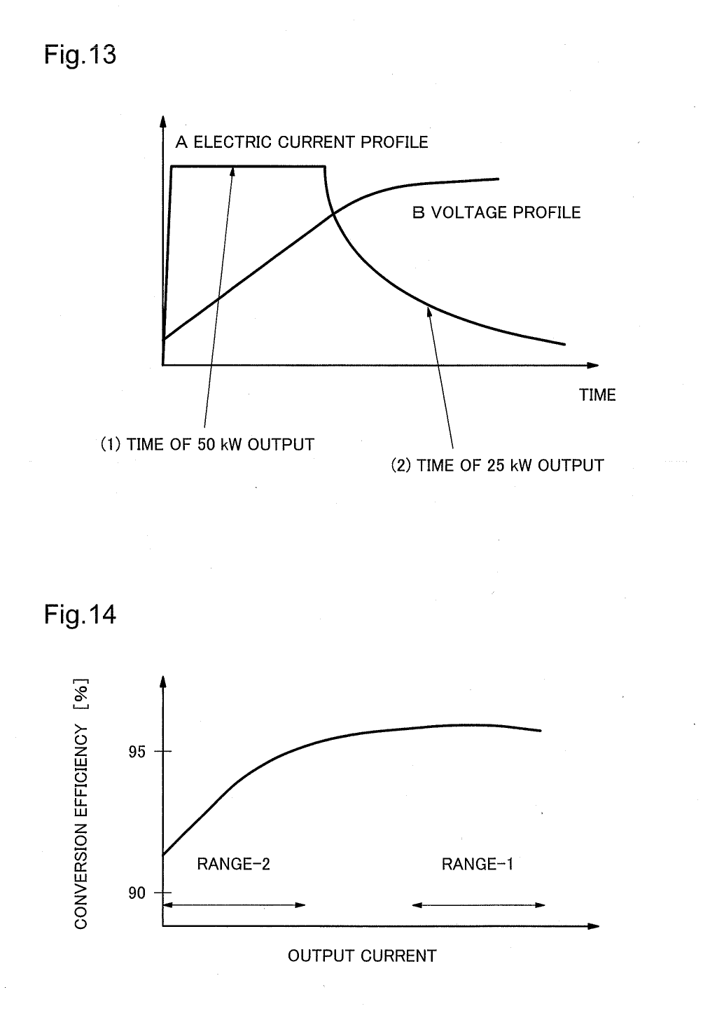

FIG. 11 indicates an example of a procedure which determines power supply circuits assigned for charging the m-th secondary battery.

The procedure of FIG. 11 overlaps with the procedure of FIG. 5 mostly. In this regard, however, there is a restriction by which power supply circuits that have been assigned for charging up to (m−1)-th secondary battery cannot be selected, and selection is made from power supply circuits which have not been selected up to (m−1)-th turn. That is, when power supply circuits needed for the output value required by the secondary battery cannot be reserved from power supply circuits remaining without having been selected (Step S404 and Step S412), a power supply circuit that is being tried to be reserved and all other power supply circuits that remain without having been selected among power supply circuits of the maximum output power smaller than that of the tried power supply circuit are selected (Step S410 and Step S413), and the procedure is finished. Meanwhile, the sum total processing of Step S404, Step S410, Step S412 and Step S413 represents calculating the sum about subscript i from one to m−1.

Further, in order to increase the charging speed of the m-th secondary battery by reserving the required output power even if the conversion efficiency is aggravated a little, a step to add a predetermined difference to required power numerical value Qₘ may be added to the subsequent stage of Step S413, and then the procedure is returned to Step S401. As a result, a power supply circuit with a large maximum output power can be secured for charging the m-th secondary battery.

When m reaches M by repeating the above mentioned procedure, the procedure of allocation of power supply circuits for charging the secondary battery is finished.

Because processing other than the above is identical to the third exemplary embodiment, description will be omitted.

By this procedure, it is possible to continue the charging procedure of the secondary battery of the high priority order while maintaining high conversion efficiency of the power supply circuit, and to use surplus power supply circuits for charging other secondary batteries. Output power corresponds finely to a state of the secondary battery to be charged, and loss due to decrease of the conversion efficiency is suppressed. As a result, a charging system operates with a less power consumption.

Also, the plurality of secondary batteries are charged in an order of priority set in advance, and the order of priority can be changed by user's instructions according to need. Accordingly, a charging system of a high flexibility charging procedure is provided.

As stated above, in the charging system of the present invention, a power supply unit includes a plurality of power supply circuits, an input power connection of this power supply circuit can be changed, and output power routes are configured by a switchable power source bus. Therefore, even when two or more electric vehicles each having a different battery remaining capacity visit the charging system, the most suitable supply power can be supplied to the plurality of vehicles simultaneously. In addition, when the output power of each of the plurality of power supply circuits included in the power supply unit is different, an operation of the charging system in the most suitable conversion efficiency is possible by changing a combination of the power supply circuits. Further, when a charging time of the secondary battery passes a certain time point, the secondary battery does not require output of the largest power value in a time zone after that. In this time zone, the power supply circuits that do not need to output are cut off in turn. The power supplies that have been cut off are used for other equipment or an electric vehicle which needs charge. By this, a charging system always operates in a state of the maximum efficiency and the maximum output.

Moreover, the power supply unit may include a plurality of redundant power supply circuits so that the power supply unit can supply output of a power value larger than the total of the largest output power values that the secondary batteries connected to the electric power output unit 8 require. As a result, even when a trouble occurs to a part of the power supply circuits supplying electric power, continuous use of the charging system is possible by cutting off the power supply circuit concerned and the switching to the redundant power supply circuit, and the number of times of maintenance or repairing of the apparatus is suppressed. In addition, although the redundant power supply circuit may be provided as a spare to prepare for the power supply unit trouble as mentioned above, it may be controlled so that the power supply circuits included in the power supply unit including redundant power supply circuits are used by rotation. Consequently, a concentrated continuous-operation of a certain power supply circuit is avoided, and a deterioration caused by continuous use of components of the power supply circuit is suppressed, resulting in a long lifetime of the charging system.

Although the present invention has been described with reference to an exemplary embodiment above, the present invention is not limited to the above-mentioned exemplary embodiments. Various modifications, which a person skilled in the art can understand, can be made to the composition and details of the present invention within the scope of the present invention.

In the above-mentioned exemplary embodiments, although a charging system and charging method for charging a secondary battery has been described, the present invention is not limited to this. The present invention can be applied suitably as a power supply circuit which supplies electric power to an electric power supply destination in which a required power value changes according to the state.

Also, in the present exemplary embodiments, although an example in which electric power supplied from an alternating current power source is divided into a plurality of secondary batteries to charge them has been described, the present invention is not limited to this. Electric power is supplied from a direct-current power source such as a battery, and then the electric power is distributed and supplied to electric power supply destinations. According to an electric power supply destination, it may be supplied after being converted into alternating current power.

The method described above may be realized by a computer reading a program from a recording medium or a communication line to carry it out.

This application is based upon and claims the benefit of priority from Japanese application Japanese Patent Application No. 2010-284138, filed on Dec. 21, 2010, the disclosure of which is incorporated herein in its entirety by reference.

### INDUSTRIAL APPLICABILITY

The present invention is not limited to the above-mentioned exemplary embodiments, and is applicable suitably as a control apparatus and a control method of a power supply circuit whose conversion efficiency depends on a load.

### DESCRIPTION OF THE REFERENCE NUMERALS

1 Charging system
2 Alternating current power source
3 Power supply unit
4 Input power connection switching unit
5 Input connection control unit
6 Output path switching unit
7 Output path control unit
8 Electric power output unit
11 Control unit
12 Input unit
31 Power supply circuit
32 Power supply circuit
33 Power supply circuit
34 Power supply circuit
35 Power supply circuit
36 Power supply circuit
41 Switch
42 Switch
43 Switch
44 Switch
45 Switch
46 Switch
51 Input connection communication unit
52 Input connection combination control unit
71 Output path communication unit
72 Output path combination control unit
81 Output unit
82 Output unit
83 Output unit
84 Output unit
85 Output unit
91 Secondary battery
92 Secondary battery
93 Secondary battery
94 Secondary battery
95 Secondary battery
101 Detection unit
102 Detection unit
103 Detection unit
104 Detection unit
105 Detection unit
1001 Charging system
1002 Alternating current power source
1003 Power supply unit
1008 An electric power output unit
1009 Secondary battery

1. A charging system, comprising:
an output unit that supplies electric power;
a plurality of electric power generating units that generate electric power of a predetermined power value;
a detection unit that detects a state of said output unit; and
a control unit that controls said plurality of electric power generating units based on said state detected by said detection unit.

2. The charging system according to claim 1, wherein
a battery is connected to said output unit, and
said control unit controls said plurality of electric power generating units based on a power value required for charging said battery.

3. The charging system according to claim 1, further comprising:
a plurality of output units, wherein
said control unit controls said plurality of electric power generating units and said plurality of output units based on a state of said plurality of output units detected by said detection unit.

4. The charging system according to claim 3, wherein
said control unit sets an operating status of said plurality of electric power generating units and a route between said plurality of electric power generating units and said plurality of output units.

5. The charging system according to claim 1, wherein
a ratio of a maximum output power value of said plurality of electric power generating units to a smallest maximum output power value is exponentiation of an integer.

6. A charging method for performing charging by electric power supplied from at least one of a plurality of electric power generating units to an output unit, comprising:
detecting a state of said output unit; and
controlling said plurality of electric power generating units based on said detected state.

7. The charging method according to claim 6, wherein,
in said controlling said plurality of electric power generating units a power value required for charging a battery connected to said output unit is determined based on said state.

8. The charging method according to claim 6, further comprising:
controlling a plurality of output units based on said state.

9. The charging method according to claim 8, wherein,
in said controlling said plurality of electric power generating units, an operating status of said plurality of electric power generating units is determined, and a route between said plurality of electric power generating units and said plurality of output units is set.

10. The charging method according to claim 6, wherein
a ratio of a maximum output power value of said plurality of electric power generating units to a smallest maximum output power value is exponentiation of an integer.

11. A non-transitory computer readable medium storing a program, causing a computer to execute a control process for performing charging by electric power supplied from at least one of a plurality of electric power generating means to an output means, the control process comprising:
detecting a state of said output means; and
controlling said plurality of electric power generating means based on said detected state.
